(19) United States
(12) Patent Application Publication
(10) Pub. No.: US 2018/0020653 A1
(43) Pub. Date: Jan. 25, 2018

(54) IMPROVEMENTS IN AND RELATING TO HORSESHOES

(71) Applicant: The 3rd Millennium Ltd, Lytham St Annes (GB)

(72) Inventor: Nicholas Charnley, Westby (GB)

(21) Appl. No.: 15/548,117

(22) PCT Filed: Feb. 2, 2016
(86) PCT No.: PCT/GB2016/050227

§ 371 Date: Aug. 2, 2017

(30) Foreign Application Priority Data
Feb. 2, 2015 (GB) 1501662.9

(51) Int. Cl. A01L 7/02; A01K 13/00; A01L 7/10

(52) U.S. Cl. CPC A01L 7/02; A01L 7/10; A01K 13/007; A01L 1/02

(57) ABSTRACT

A horseshoe (10) comprising a relatively rigid insert (14) operatively connected to a sole (12), the relatively rigid (14) insert typically being made of metal and being generally U-shaped with a front, central portion and a pair of spaced-apart branches extending from opposite ends of the central portion. The sole (12), in certain embodiments, is overmoulded onto the insert (14) and forms a “frog” for protecting the sole of a hoof and through which loads can be transmitted to a walking surface. The sole (12) comprises central portion having a generally W-shaped lateral cross-section (76) comprising an apex (70) and a valley (74, 76) interposed between the apex (70) and each of the branches. Thus, when a load (82) is applied to the sole (12) of the shoe (10) from above, the apex (70) of the W-cross-sectioned portion (76) of the sole (12) is depressed, and this deflection spreads the sole (12) such that it exerts a radially outward force onto the branches of the metal insert (14), thus widening the shoe (10). This expansion corresponds substantially to the natural expansion of an un-shod hoof under load. The shoe (10) may additionally have a crease (12) comprising a plurality of radially inwardly and radially outwardly displaced notches for positioning nail heads at different radial and circumferential positions. The sole (12) may further comprise a glue/cushioning retaining lip (42).

Traditional horseshoes comprising a generally U-shaped metal bar, which is nailed to a horse's hoof have been around for millennia and generally meet the principal purpose of a horseshoe, which is to say, to reduce excessive wear of the horse's hoof and provide grip. Traditional metal horseshoes, however, do not protect the sole (or frog) of a horse's hoof, which remains exposed. This can create difficulties for horses when, for example, they walk on gravel surfaces, or when the sole or frog are damaged.

It is known to provide soled horseshoes, that is to say horseshoes comprising a generally flat plate which can be affixed to the underside of the hoof, which protects the solar part of the hoof. The plate is thus interposed, in use, between the frog of the hoof and the walking surface, thereby affording protection and/or cushioning etc. depending on the material of manufacture of the sole.

Soled horseshoes, especially those manufactured from plastics, are susceptible to wear and distortion under constant load, and so it is also known to provide a hybrid horseshoe comprising both a plastics sole and a generally U-shaped metal insert encapsulated within the plastics sole, which offers the advantages of both a traditional metal horseshoe and a soled horseshoe. This invention is particularly concerned with improvements in and relating to hybrid horseshoes of this general type.

Examples of known hybrid horseshoes are described in published patent UK application number GB2513374 and published European patent application number EP2181592, which describe pads that can be affixed to a traditional horseshoe. Published US patent application number U.S. Pat. No. 4,513,824 describes another plastic horseshoe, which comprises a flexible joint.

Known hybrid horseshoes, such as those mentioned above, nevertheless suffer from a number of disadvantages.

First, because the metal insert is encapsulated within the plastics sole component, the plastics component surrounding the metal insert tends to wear away quickly exposing the metal insert, which can then sometimes work free and fall out. If this happens, especially whilst the horse is in locomotion, the metal insert can be “thrown”, which can be dangerous to the rider, the horse and bystanders.

Second, because the plastic component encapsulates the metal insert of known hybrid horseshoes, the plastics component, rather than the metal insert, tends to be in contact with the walking surface, which can reduce traction.

Third, due to the composite structure of known hybrid horseshoes, the flexibility of the horseshoe tends to be extremely restricted, and this inhibits the natural flexion of the horse's hoof during locomotion. This is particularly the case for known hybrid horseshoes because the sole bridges the branches of the metal insert, thereby inhibiting splaying of the metal insert as the horse's weight is applied through its hoof. This restriction of the natural flexion of the horse's hoof can lead to contracted heels, causing discomfort and/or medical complications for the horse, which are undesirable.

Fourth, due to the construction of known hybrid horseshoes, there can be a tendency for debris and stones to work their way into the void between the sole of the horseshoe and the frog of the horse's hoof. This can lead to considerable discomfort to the horse, and because the dirt/debris cannot be easily removed from this location, it is necessary to use some type of material to fill the void to prevent this ingression.

Fifth (and this is also the case for traditional horseshoes), the farrier has limited options when nailing a known horseshoe to a horse's hoof. However, because the thickness of the horn (the hard side wall of the hoof) varies from one animal to the next, a farrier can sometimes accidently nail into the hoof's sensitive lamellae, which can cause the horse a great deal of distress and also endanger the farrier. The known solution to this problem is to adjust the horseshoe manually with heat, in a forge, a hammer, anvil and rasp to allow the position of the nail holes to be radially offset, but this is time consuming and therefore more expensive.

A need therefore exists for a solution to one or more of the above problems and/or an alternative horseshoe.

Various aspect of the invention are set forth in the appendent claims.

According to an aspect of the invention, there is provided a horseshoe comprising a relatively rigid insert operatively connected to a sole, the relatively rigid insert being generally U-shaped and comprising a front, central portion and a pair of spaced-apart branches extending from opposite ends of the central portion, the sole comprising an undulating central portion extending between the branches, the undulating central portion comprising a generally W-shaped lateral cross-section comprising an apex and a valley interposed between the apex and each of the branches, whereby, in use, flattening of the undulating portion causes the central portion to exert a spreading force to the branches of the insert.

Suitably, the central portion comprises at least one apex and at least one valley, whereby, in use, flattening of the undulating portion causes the central portion to exert a spreading force to the branches of the insert. The central portion suitably comprises a generally W-shaped lateral cross-section comprising an apex and a valley interposed between the apex and each of the branches.

At least part of the central portion may be reticulated. The reticulated portion, where provided, may be adapted to accommodate lateral expansion and/or lateral compression of the central portion.

Suitably, the central portion comprises a frog support element. The frog support element, where provided, may comprise one or more downwardly-projecting ribs, which rib may be chevron-shaped when viewed from below. The apex of the or each chevron may be substantially centred on the longitudinal midline of the central portion.

Suitably, the insert is resiliently deformable, for example, by being manufactured from light gauge steel, or from aluminium. The sole may be manufactured from an injection moulded plastics or elastomeric material, such as PU, PE, PP. The sole may be manufactured from a transparent or translucent material, which may facilitate inspection of the underside of a horse's hoof, when fitted.

Suitably, the insert and sole are integrally formed. This may be accomplished by overmoulding the sole onto the insert. Suitably, therefore, the insert may comprise an inwardly projecting groove comprising a relatively narrow entry portion leading to a relatively wider internal portion. In other words, the inwardly projecting groove may have a substantially mushroom-shaped cross-section.

Suitably, the insert comprises a nail head-receiving crease, the crease comprising a relatively narrow groove extending around the floor-engaging surface of the insert, wherein the crease comprises a plurality of radially inwardly and radially outwardly displaced notches for receipt, in use, of nail heads at different radial and circumferential positions.

The or each notch may comprise an indentation extending into an inner or an outer sidewall of the crease. Suitably, the notches, where provided, are shaped and sized to snugly receive one side of the head of a nail, and such that, in use, the opposite side of the nail abuts or engages the opposite side wall of the crease.

A hard wearing (e.g. steel) insert located in the crease in the central portion of the insert and/or at or towards the tips of the branches of the insert.

A frontal portion of the sole may project forward, in use, of the central portion of the insert. The frontal portion, where provided, may comprise a radiussed profile to blend the frontal edge of the sole into the profile of the metal insert and/or it may comprise a series of stepped ledges that blend the frontal edge of the sole into the profile of the metal insert.

Suitably, an upper surface of the sole comprises a resiliently deformable lip extending around, and spaced radially inwardly of, the peripheral edge of the sole. The lip, where provided, may be integrally formed with the sole.

Another aspect of the invention provides a horseshoe comprising a nail head-receiving crease, the crease comprising a relatively narrow groove extending around a floor-engaging surface of the horseshoe, wherein the crease comprises a plurality of radially inwardly and radially outwardly displaced notches for receipt, in use, of nail heads at different radial and circumferential positions.

Suitably, the or each notch comprises an indentation extending into an inner or an outer sidewall of the crease. Suitably, the notches are shaped and sized to snugly receive one side of the head of a nail, and wherein, in use, the opposite side of the nail abuts or engages the opposite side wall of the crease.

Another aspect of the invention provides a horseshoe comprising a relatively rigid, generally U-shaped insert operatively connected to a sole, wherein an upper surface of the sole comprises a resiliently deformable lip extending around, and spaced radially inwardly of, the peripheral edge of the sole.

The lip is suitably integrally formed with the sole.

Another aspect of the invention provides a horseshoe comprising a relatively rigid insert operatively connected to a sole, the relatively rigid insert being generally U-shaped and comprising a front, central portion and a pair of spaced-apart branches extending from opposite ends of the central portion, the sole comprising a central portion extending between the branches, wherein the sole is overmoulded onto the insert.

Suitably, the insert comprises an inwardly projecting groove comprising a relatively narrow entry portion leading to a relatively wider internal portion into which groove, the sole is overmoulded. Suitably, the inwardly projecting groove has a substantially mushroom-shaped cross-section.

Another aspect of the invention provides a locator suitable, in use, for temporarily affixing an adhesively bonded horseshoe to a hoof, the locator comprising a planar spacer element having a thickness corresponding to the desired final thickness of the adhesive and a pair of projections extending outwardly from opposite faces of the spacer element, a first one of the projections having a pointed shape and being adapted, in use, to be driven into the lamellae of a horse's hoof, and the other one of the projections having a generally cuboid shape adapted, in use, to locate in a recess of a crease (e.g. into a nail hole on the solar aspect) of a horseshoe.

Embodiments of the invention shall now be described, by way of example only, with reference to the accompanying drawings in which:

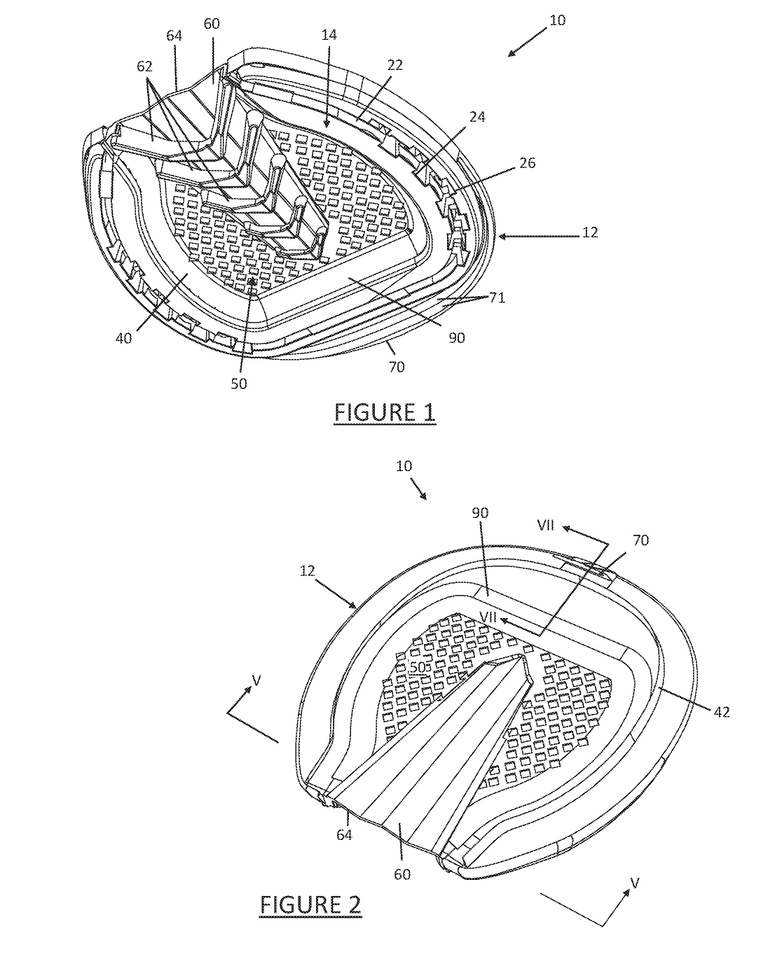

FIG. 1 is a perspective view from below of a horseshoe in accordance with the invention;

FIG. 2 is a perspective view from above of the horseshoe of FIG. 1;

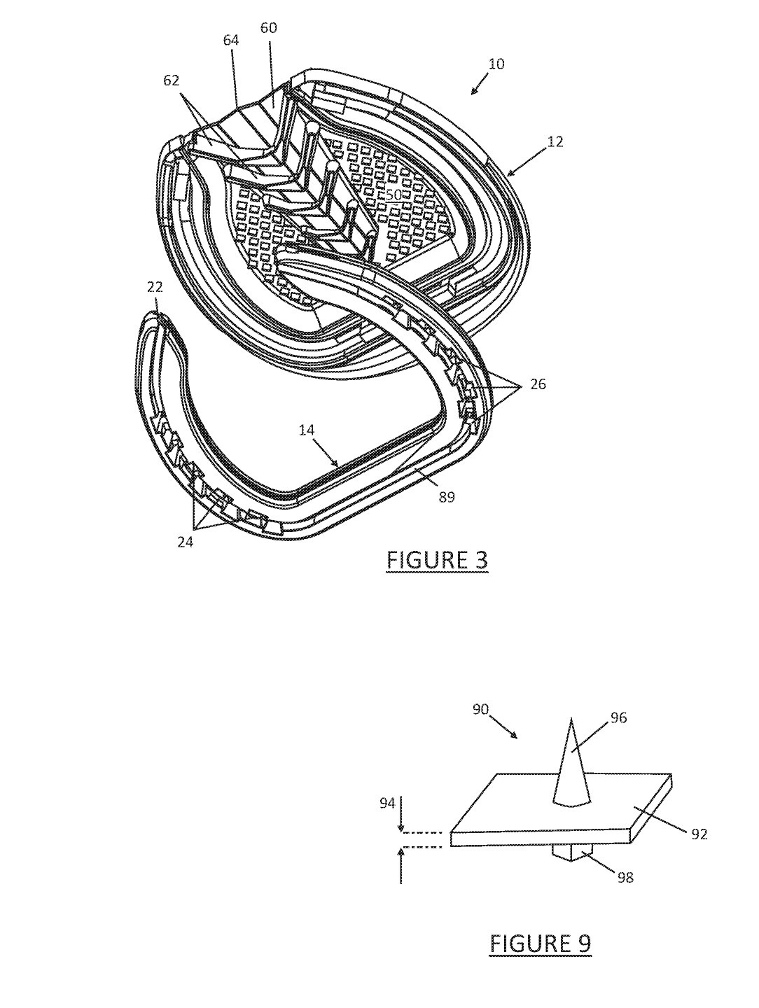

FIG. 3 is an exploded view of the horseshoe of FIG. 1;

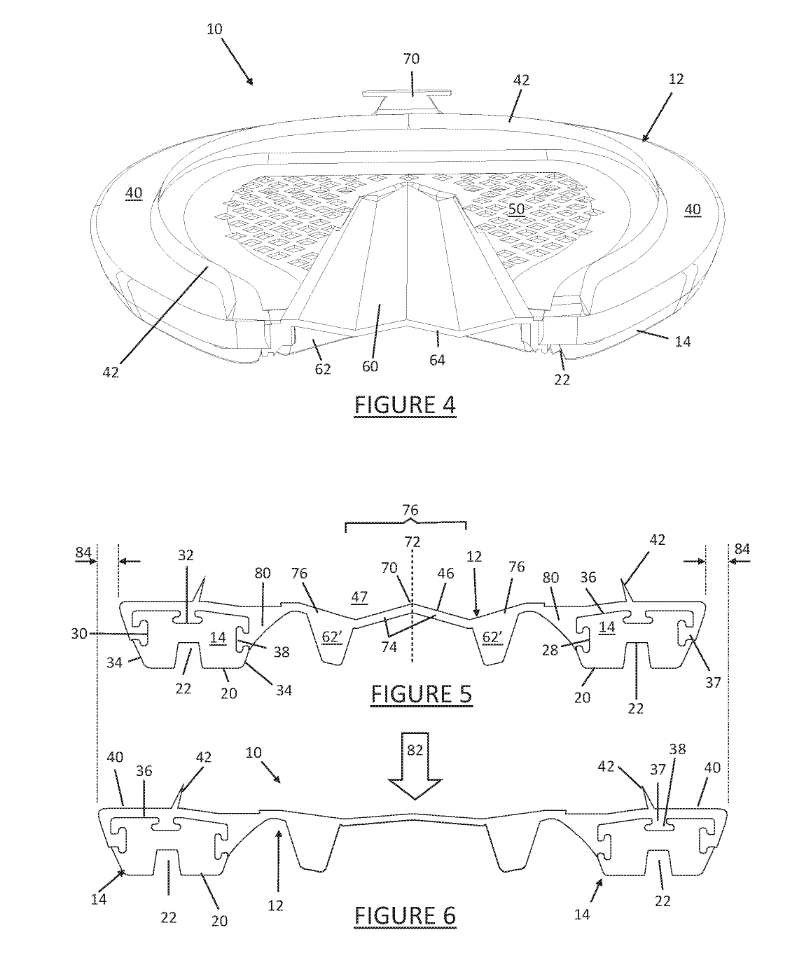

FIG. 4 is a perspective view from the rear of the horseshow of FIG. 1;

FIG. 5 is a cross-section of FIG. 1 on V-V;

FIG. 6 is a hypothetical cross-section of the FIG. 2 on V-V in a spread configuration;

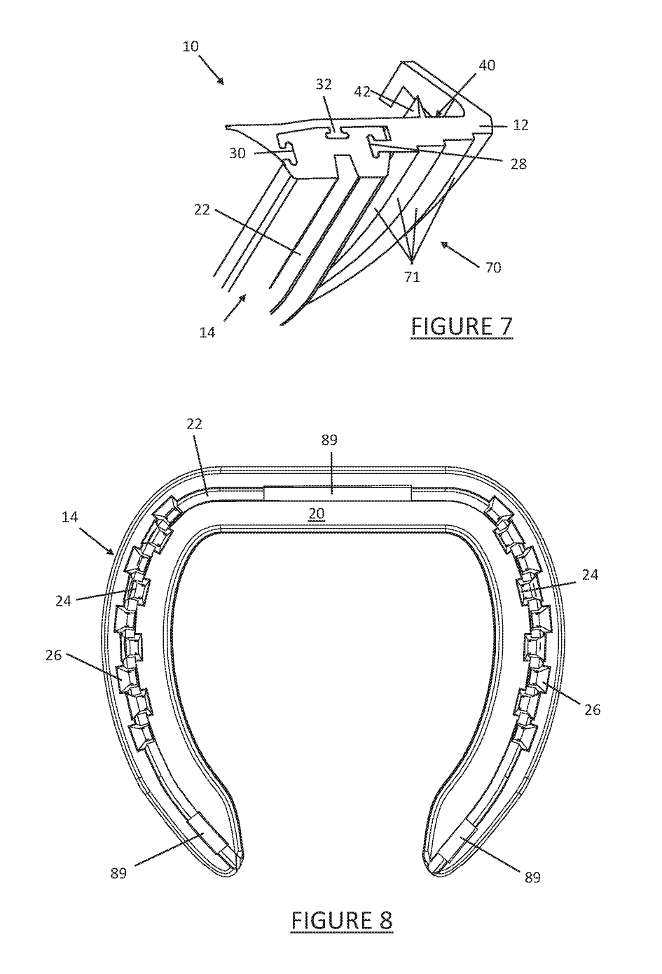

FIG. 7 is a cross-section of FIG. 2 on VII-VII;

FIG. 8 is a perspective view from below of the metal insert of FIG. 3; and

FIG. 9 is a perspective view of a locator suitable to aiding the fitting of a glued horseshoe.

In FIGS. 1 to 8 of the drawings, an exemplary embodiment of a horseshoe 10 in accordance with the invention comprises a sole 12 manufactured from an injection moulded polymer material, which is over-moulded onto a generally U-shaped metal insert 14. In use, the metal insert 14 engages the ground or other walking surface and functions in a similar manner to a conventional horseshoe. The sole 12 is interposed, in use, between the metal insert 14 and the underside of a horse's hoof (not shown). The horseshoe 10 can be attached to a horse's hoof using nails and/or adhesive, as shall be described in greater detail below. Thus, the horseshoe 10 provides a durable/hard-wearing component (i.e. the metal insert 14), which protects the horse's hoof from premature wear, and provides traction, as well as a sole 12, which protects the sole and frog of the horse's hoof.

The horseshoe 10 of the invention differs from known horseshoes in a number of respects as shall be elucidated below.

Referring now in particular to FIGS. 5 and 7 of the drawings, it can be seen that the cross-section of the metal insert 14 is generally H-shaped having a generally flat, lower surface 20, which engages the ground or walking surface, in use. The lower surface 20 comprises a crease 22, in the form of a generally U-shaped channel, which runs approximately around the midline of the lower surface 20 of the metal insert 14. The generally U-shaped crease 22 is formed initially by an extrusion process during the manufacture of the metal insert 14, to define a relatively narrow crease 22. A subsequent forging process is then employed to deform (i.e. widen) the crease in certain areas, as can be seen more clearly in FIGS. 1, 3 and 8 of the drawings. The deformation of the crease 22 provides alternately inwardly 24 and outwardly 26 offset recesses for receipt, in use, of farrier's nail heads. It will be noted that the inwardly 24 and outwardly 26 displaced recesses are wider than the original, relatively narrow crease 22. Such a configuration provides a farrier with the option to affix the horseshoe 10 to the horse's hoof using “fine” or “coarse” nails, i.e. nails located closer to, or further away from, the wall of the horse's hoof (not shown). Further, the farrier has a choice (in the illustrated example) of nail placement in any one of nine or more recesses 24, 26 in each branch of the metal insert 14, thus affording a great deal of flexibility in the attachment of the horseshoe 10 to the hoof.

It will also be noted that the generally rectangular-shaped notches 24, 26 in the crease 22 provide rectangular-shaped receiving recesses for the heads of farrier's nails, unlike known horseshoes, which have a crease with pre-punched holes along the centre-line, restricting options regarding the positioning of the nails. The invention provides a set of engineered recesses that are shaped and sized to match the shape of the nail heads. In particular, the nail heads of the invention are retained on radially opposite sides and on the radially outward corners of the fine holes and inward corners of the coarser holes. This improves the retention of nails by reducing the amount of movement that is possible.

The cross-section of the metal insert 14 additionally comprises a set of inwardly-projecting grooves 28, 30, 32, one on each of the inner and outer lateral surfaces 34 of the metal insert 14 and one on the upper surface 36 of the metal insert. Each groove 28 comprises a relatively narrow external portion 37, which leads into to a relatively wider internal portion 38, thus defining a generally mushroom-shaped cross-section, as can be seen in particular in FIGS. 5, 6 and 7 of the drawings. This configuration of grooves 28, 30, 32 enables the plastics sole portion 12 to be over-moulded onto the metal insert 12 leaving the lower surface 20 of the metal insert 12 exposed to engage the ground or walking surface, in use. This has a number of advantages compared with known horseshoes, which are not manufactured in this manner. First, the plastics sole 12 does not overlie the underside of the metal inert 14 (as would be the case if the metal insert were encapsulated in the plastics sole, as is the case in known horseshoes of this general type). This avoids the horseshoe having a relatively slippery floor contact surface. Second, because the plastics sole 12 does not overlie the underside of the metal inert 14, the sole 12 is not worn away prematurely—potentially leading to throwing or detachment of the metal insert 14 from the horseshoe 10.

As mentioned above, the horseshoe 10 may additionally or alternatively be affixed to a horse's hoof by an adhesive applied to the peripheral region 40 of the upper surface of the sole 12, as indicated in FIG. 2. Typically, a fast-curing, two-part resin adhesive is used for this purpose, and suitable adhesives will be well-known to the skilled reader, and in particular to farriers. To adhere a horseshoe 10 to a horse's hoof, the adhesive is applied to the region 40 previously described, and the horseshoe 10 is pressed onto the underside of the horse's hoof (not shown). Because at least initially, the adhesive is in a liquid or gel state, it tends to spread, under the application of firm pressure, both radially outwardly to form a flashing, which can be easily removed subsequently using a blade or other tool; or radially inwardly towards the sensitive sole of the horse's hoof. The latter-mentioned displacement of adhesive is highly undesirable because when the adhesive sets hard, the horse can feel the adhesive underfoot during walking: a sensation somewhat similar to a human having a stone in his/her shoe. Over a period of time, this can lead to pressure sores on the horse's sole and potential formation of abscesses or other medical complications.

To overcome this, the horseshoe 10 of the invention is provided with a resiliently deformable lip 42 on the upper surface of the sole 12, which inscribes the inner periphery of the area 40 to which adhesive is applied, in use. The resiliently deformable lip 42 is shown, in particular, in FIGS. 2, 4, 5, 6 and 7 of the drawings, and it comprises a generally triangular cross-sectioned lip having a relatively fine base and sidewalls tapering to a finer tip that is inclined slightly towards the either the centre (as shown in the drawings) or the outside (not shown in the illustrated example) of the horseshoe 10. When the horseshoe 10 is pressed against the underside of a horse's hoof (not shown), the lip 42, easily deflects radially inwardly (or outwardly if the rip is angles the other way) such that its tip conforms to the profile of the underside of the horse's hoof (not shown) to form a seal. Thus, when adhesive is applied to region 40 and the horseshoe 10 pressed firmly against the underside of the horse's hoof (not shown), radially inward spreading of the adhesive bead (not shown) is constrained by the lip 42, thus inhibiting or preventing the displacement of the adhesive onto the sensitive solar part of the horse's hoof. Thus, excess adhesive is constrained to squirt radially outwardly, where it can be easily removed during curing or after curing.

The exemplary horseshoe 10 additionally provides for the addition of a cushioning layer and/or medicating treatment to the frog of the horse's hoof. Specifically, the sole portion 12 of the horseshoe 10 has an undulating cross-section, which can be seen in particular in FIGS. 4, 5 and 6 of the drawings. The undulating profile of the sole 12 forms a void 47 between the upper surface 46 of the sole 12 and the underside of the frog of the horse's hoof (not shown), which void 47 can be backfilled with cushioning material, such as a setting elastomeric gel, or a medicament, by injection of the desired material into the void from the rear of the horseshoe 10, when fitted.

It will be noted that the lip 42 previously described serves to inhibit or prevent or inhibit radially outward displacement of the cushioning material or medicament, thus inhibiting mixing and/or adverse interaction between the cushioning material or medicament and the adhesive (where used) and/or the cushioning material or medicament and the horn of the horse's hoof. The provision of the lip 42 thus permits the application of an adhesive and a medicating/cushioning layer substantially simultaneously or in quick succession.

It will also be noted, in particular, from FIGS. 1, 2, 3 and 4 of the drawings, that the sole 12 comprises a reticulated structure 50, whose function shall be described in greater detail below. Nevertheless, it will be noted that excess cushioning material or medicament can flow out through the holes of the reticulated structure 50, to prevent over-filling of the void 47 with cushioning material or medicament; or forming a bulge of cushioning material or medicament on the underside of the horse's hoof. In certain embodiments of the invention, the apertures of the reticulated structure 50 are covered by a thin layer of flashing, or a self-adhesive web, to inhibit the ingress of sand/dirt into the void between the sole 12 and the frog of the horse's hoof (not shown).

One of the main features of horseshoes 10 in accordance with the invention shall now be described with particular reference to FIGS. 1, 4, 5 and 6 of the drawings, from which it can be seen that the sole 12 of the horseshoe 10 comprises a frog support 60 formed by a set of several spaced-apart, chevron-shaped integral mouldings 62 arranged in a line extending from the rear edge 64 of the sole 12 along its midline. The frog support 60 provides additional support to the horse's hoof, and enables the weight of the horse to be distributed between the horn of the hoof (into the ground or walking surface via the metal insert 14) and the frog support 60 (into the ground between the frog of the horse's hoof and the frog support 60 of the horseshoe 10). Such a configuration provides a number of advantages inasmuch as the distribution of forces in the horse's hoof is more akin to its natural (un-shod) condition, as well as the frog support 60 of the horseshoe 10 providing additional traction. Further, the frog support 60 facilitates the horse walking on gravel or stony surfaces, which can be uncomfortable for a horse wearing a conventional, metal-only horseshoe.

When a horse is un-shod, its hoof tends to spread as weight is applied to each leg. The spreading occurs generally radially outwardly due to the anatomy of the hoof and the shape of the horn of the hoof. A conventional, metal-only horseshoe, whilst having a small degree of flexibility in its branches, tends to inhibit the natural spreading of the horse's hoof under the application of loads. Moreover, known hybrid horseshoes (similar to the invention) comprising a sole and a metal insert tend to afford even less movement of the horse's hoof because the sole of known hybrid horseshoes tends to restrict or counteract the spreading of the metal insert's branches. The result can be an unnatural movement in the horse's hoof, which over time, can lead to orthopaedic problems in certain animals. This is often characterised in excessive or exaggerated movement or flexion at the heel, to compensate for the lack of movement in the restricted nailed portion of a rigid shoe, leading to the commonly known syndrome of “long toe low heel”.

The invention 10, by stark contrast to known horseshoes, provides a solution to the problem of restricted spreading of the metal insert 14 by the configuration of its sole, and in particular, by the configuration of its frog support 60. This is shown in particular, in FIGS. 4, 5 and 6 of the drawings.

As can be seen from FIGS. 5 and 6, the chevrons 62 of the frog 60 are integrally formed with the sole 12 of the shoe 10 and the portion 76 of the sole 12, which is interposed between the branches 62′ of each chevron, has a generally W-shaped cross section. The W-cross-section portion 76 comprises a raised central apex 70 aligned with the sole's midline 72. A first pair of downwardly inclined lateral web portions 74 extend from the apex 70 to a point where the branches 62′ of the chevrons 62 are integrally formed with the underside of the sole 12. A second pair of upwardly inclined lateral web portions 78 extend between the point where the branches 62′ of the chevrons 62 are integrally formed with the underside of the sole 12 and the peripheral edge of the sole 12 where it meets the metal insert 14. A concave flashing 80 is also provided where the upwardly inclined lateral web portions 78 meet the metal insert 14, to prevent clogging and facilitate the natural, self-removal of debris from the shoe, such as mud or sod etc.10.

As can be seen by comparing FIG. 5 with FIG. 6, when a point, or distributed, load 82 is applied to the sole 12 of the shoe 10 from above, the apex 70 of the W-cross-sectioned portion 76 of the sole 12 is depressed. This deflection spreads the first 74 and second 76 pairs of lateral webs, which exert a radially outward force onto the branches of the metal insert 14, thus widening the shoe 10. The amount of deflection and widening 84 is exaggerated in FIG. 6, but it will be appreciated that the amount of deflection and widening 84 can be adjusted by any one or more of: the appropriate selection of the materials of manufacture of the sole 12; the thickness of the first 74 and second 76 lateral web portions; the angle of inclination of the first 74 and second 76 lateral web portions; and the material and section of the metal insert 14.

Referring back to FIGS. 1 to 4 of the drawings, the reticulated portion 50 of the sole 12 plays an important role in the flexion of the shoe 10 inasmuch as the reticulated structure 50 enables the sole 12 to be stretched or compressed without wrinkling. In other words, as the shoe 10 spreads the angles of the reticulated structure 50 change to accommodate the widening of the sole 12, and vice-versa. Similarly, the reticulated structure 50 of the sole 12 also allows a farrier to make adjustments to the width of the metal insert 14 (e.g. by hammering) without creasing or wrinkling the sole, which could potentially prevent a perfect fit (creases and wrinkles, of course are also potential causes of pressure sores and other irritation to the horse).

It will be noted also, from FIGS. 1 and 7, in particular, of the drawings, that the front of the shoe 10 comprises a breakover section 70. The breakover section 70 is integrally formed with the front of the sole 12 of the shoe 10 and provides a series of stepped ridges 71. This configuration enables the front part of the metal insert 14 to be set back from the front of the shoe 10, thus moving the pivot point/breakover point of the shoe rearward, reducing tension in the DDFT and pressure on the navicular bone. This rolling of the hoof during locomotion, has proven, in studies, to be generally beneficial to most horses. A relatively hard, metal insert 89 is also pressed into the front portion of the crease 22 to reduce premature wear of the metal insert 14 in its most wear-vulnerable region.

When fitting a horseshoe with adhesive, a farrier may often find it difficult to ensure that the animal remains still for sufficient time to allow the adhesive to fully set or cure. If the animal stands on an adhesively-bonded shoe before the adhesive has completely set or cured, it is likely that the shoe 10 will tilt, cant or twist relative to the hoof, which necessitates re-shoeing.

A further aspect of the invention 10 offers a solution to this problem by way of a locator 90, which is shown in FIG. 9 of the drawings. The locator 90 may be used to facilitate affixing an adhesively bonded horseshoe 12, such as that described above, to a horse's hoof.

The locator 90 comprises a planar spacer element 92 having a thickness 94 corresponding to the desired final thickness of the adhesive and a pair of projections 96, 98 extending outwardly from opposite faces of the spacer element 92. The first one 96 of the projections has a pointed shape, and this can be driven into the lamellae of the horse's hoof, whereas the other one 98 of the projections has a generally cuboid shape and locates into the nail holes on the solar side (not shown) of the metal insert 14 of the hybrid horseshoe (or the nail head holes of a conventional horseshoe).

In use, the locator 90 can be fitted to the horseshoe by locating the second projection 98 into the desired nail hole and adhesive applied to the shoe 10 in the usual way. The shoe 10 can then be offered up to the hoof and tapped into position to locate the pointed projection 96 into the hoof's lamellae. This temporarily holds the shoe 10 in position whilst the adhesive sets. If a plurality of locators 90 are used, the spacing of the horseshoe 10 from the underside of the hoof will be even, which ensures uniform section thickness of the adhesive between the shoe 10 to the hoof. Thereby maintaining the dorso-palmer and medio-lateral balance of the trimmed hoof provided by the farrier. Further, if the horse applies weight to the shoe 10 before the adhesive has fully set, the spacer element 92 is able to bear the weight (at least in the short term) preventing the shoe from canting or tilting relative to the hoof. Further should a horse apply weight to the shoe 10 prior to the adhesive fully setting, any torsion applied to the hoof does not result in the shoe 10 twisting relative to the hoof because the pointed projections 96 are engaged with the hoof's lamellae, thereby inhibiting or preventing relative lateral movement or slippage of the shoe 10 relative to the hoof.

The invention is not restricted to the details of the foregoing embodiments, which are merely exemplary of the invention. In particular, any shoes, sizes, configurations, materials etc. whether explicit or implied, are illustrative only. Further, whilst the invention has been described in relation to horse shoes, it will be readily apparent that the invention could be used on other hoven animals requiring shoes.

The following statements are not the claims, but relate to various features, embodiments or aspects of the invention:
Statement 1. A horseshoe comprising a relatively rigid insert operatively connected to a sole, the relatively rigid insert being generally U-shaped and comprising a front, central portion and a pair of spaced-apart branches extending from opposite ends of the central portion, the sole comprising an undulating central portion extending between the branches.
Statement 2. The horseshoe of statement 1, wherein the central portion comprises at least one apex and at least one valley, whereby, in use, flattening of the undulating portion causes the central portion to exert a spreading force to the branches of the insert.
Statement 3. The horseshoe of statement 1 or statement 2, wherein the central portion comprises a generally W-shaped lateral cross-section comprising an apex and a valley interposed between the apex and each of the branches.
Statement 4. The horseshoe of any preceding statement, wherein at least part of the central portion is reticulated.
Statement 5. The horseshoe of statement 4, wherein the reticulated portion is adapted to accommodate lateral expansion and/or lateral compression of the central portion.
Statement 6. The horseshoe of any preceding statement, wherein the central portion comprises a frog support element.
Statement 7. The horseshoe of statement 6, wherein the frog support comprises one or more downwardly-projecting ribs.
Statement 8. The horseshoe of statement 6, wherein the or each rib is chevron-shaped when viewed from below and wherein the apex is substantially centred on the longitudinal midline of the central portion.
Statement 9. The horseshoe of any preceding statement, wherein the insert is resiliently deformable.
Statement 10. The horseshoe of any preceding statement, wherein the insert is manufactured from steel or aluminium.
Statement 11. The horseshoe of any preceding statement, wherein the sole is manufactured from an injection moulded plastics or elastomeric material.
Statement 12. The horseshoe of any preceding statement, wherein the insert and sole are integrally formed.
Statement 13. The horseshoe of statement 12, wherein the sole is overmoulded onto the insert.
Statement 14. The horseshoe of statement 13, wherein the insert comprises an inwardly projecting groove comprising a relatively narrow entry portion leading to a relatively wider internal portion.
Statement 15. The horseshoe of statement 14, wherein the inwardly projecting groove has a substantially mushroom-shaped cross-section.
Statement 16. The horseshoe of any preceding statement, wherein the insert comprises a nail head-receiving crease, the crease comprising a relatively narrow groove extending around the floor-engaging surface of the insert, wherein the crease comprises a plurality of radially inwardly and radially outwardly displaced notches for receipt, in use, of nail heads at different radial and circumferential positions.
Statement 17. The horseshoe of statement 16, wherein each notch comprises an indentation extending into an inner or an outer sidewall of the crease.
Statement 18. The horseshoe of statement 17, wherein the notches are shaped and sized to snugly receive one side of the head of a nail, and wherein, in use, the opposite side of the nail abuts or engages the opposite side wall of the crease.
Statement 19. The horseshoe of any of statements 16, 17 or 18, further comprising a steel insert located in the crease in the central portion of the insert.
Statement 20. The horseshoe of any of statements 16 to 19, further comprising a steel insert located in the crease at or towards the tips of the branches of the insert.
Statement 21. The horseshoe of any preceding statement, wherein a frontal portion of the sole projects forward, in use, of the central portion of the insert.
Statement 22. The horseshoe of statement 21, wherein the frontal portion comprises a radiussed profile to blend the frontal edge of the sole into the profile of the metal insert.
Statement 23. The horseshoe of statement 21, wherein the frontal portion comprises a series of stepped ledges that blend the frontal edge of the sole into the profile of the metal insert.
Statement 24. The horseshoe of any preceding statement, wherein an upper surface of the sole comprises a resiliently deformable lip extending around, and spaced radially outwardly of, the peripheral edge of the sole.
Statement 25. The horseshoe of statement 24, wherein the lip is integrally formed with the sole.
Statement 26. A horseshoe comprising a nail head-receiving crease, the crease comprising a relatively narrow groove extending around a floor-engaging surface of the horseshoe, wherein the crease comprises a plurality of radially inwardly and radially outwardly displaced notches for receipt, in use, of nail heads at different radial and circumferential positions.
Statement 27. The horseshoe of statement 26, wherein each notch comprises an indentation extending into an inner or an outer sidewall of the crease.
Statement 28. The horseshoe of statement 27, wherein the notches are shaped and sized to snugly receive one side of the head of a nail, and wherein, in use, the opposite side of the nail abuts or engages the opposite side wall of the crease.
Statement 29. A horseshoe comprising a relatively rigid, generally U-shaped insert operatively connected to a sole, wherein an upper surface of the sole comprises a resiliently deformable lip extending around, and spaced radially inwardly of, the peripheral edge of the sole.
Statement 30. The horseshoe of statement 29, wherein the lip is integrally formed with the sole.
Statement 31. A horseshoe comprising a relatively rigid insert operatively connected to a sole, the relatively rigid insert being generally U-shaped and comprising a front, central portion and a pair of spaced-apart branches extending from opposite ends of the central portion, the sole comprising a central portion extending between the branches, wherein the sole is overmoulded onto the insert.
Statement 32. The horseshoe of statement 31, wherein the insert comprises an inwardly projecting groove comprising a relatively narrow entry portion leading to a relatively wider internal portion into which groove, the sole is overmoulded.
Statement 33. The horseshoe of statement 32, wherein the inwardly projecting groove has a substantially mushroom-shaped cross-section.
Statement 34. A horseshoe substantially as hereinbefore described, with reference to, and as illustrated in, FIGS. 1 to 8 of the drawings.
Statement 35. A locator suitable, in use, for temporarily affixing an adhesively bonded horseshoe to a hoof, the locator comprising a planar spacer element having a thickness corresponding to the desired final thickness of the adhesive and a pair of projections extending outwardly from opposite faces of the spacer element, a first one of the projections having a pointed shape and being adapted, in use, to be seated into the lamellae of a horse's hoof, and the other one of the projections having a generally cuboid shape adapted, in use, to locate in a nail hole on the solar side of a horseshoe.
Statement 36. A locator substantially as hereinbefore described, with reference to, and as illustrated in, FIG. 9 of the drawings.

1. A horseshoe comprising a relatively rigid insert operatively connected to a sole, the relatively rigid insert being generally U-shaped and comprising a front, central portion and a pair of spaced-apart branches extending from opposite ends of the central portion, the sole comprising an undulating central portion extending between the branches, the undulating central portion comprising a generally W-shaped lateral cross-section comprising an apex and a valley interposed between the apex and each of the branches, whereby, in use, flattening of the undulating portion causes the central portion to exert a spreading force to the branches of the insert.

2. The horseshoe of claim 1, wherein at least part of the central portion is reticulated, the reticulated portion being adapted to accommodate lateral expansion and/or lateral compression of the central portion.

3. (canceled)

4. The horseshoe of claim 1, wherein the central portion comprises a frog support element, the frog support element comprising one or more downwardly-projecting ribs, the or each rib being chevron-shaped when viewed from below and wherein the apex is substantially centred on the longitudinal midline of the central portion.

5. (canceled)

6. (canceled)

7. (canceled)

8. The horseshoe of claim 1, wherein the insert is manufactured from resilient steel or aluminium.

9. The horseshoe of claim 1, wherein the sole is manufactured from an injection moulded plastics or elastomeric material.

10. The horseshoe of claim 1, wherein the insert and sole are integrally formed by the sole being overmoulded onto the insert.

11. (canceled)

12. The horseshoe of claim 10, wherein the insert comprises an inwardly projecting groove comprising a relatively narrow entry portion leading to a relatively wider internal portion.

13. (canceled)

14. The horseshoe of claim 1, wherein the insert comprises a nail head-receiving crease, the crease comprising a relatively narrow groove extending around the floor-engaging surface of the insert, wherein the crease comprises a plurality of radially inwardly and radially outwardly displaced notches for receipt, in use, of nail heads at different radial and circumferential positions.

15. The horseshoe of claim 14, wherein each notch comprises an indentation extending into an inner or an outer sidewall of the crease.

16. The horseshoe of claim 14, wherein the notches are shaped and sized to snugly receive one side of the head of a nail, and wherein, in use, the opposite side of the nail abuts or engages the opposite side wall of the crease.

17. The horseshoe of claim 14, further comprising a steel insert located in the crease in the central portion of the insert.

18. The horseshoe of claim 14, further comprising a steel insert located in the crease at or towards the tips of the branches of the insert.

19. The horseshoe of claim 1, wherein a frontal portion of the sole projects forward, in use, of the central portion of the insert, the frontal portion comprising:
a radiussed profile to blend the frontal edge of the sole into the profile of the metal insert; and
a series of stepped ledges that blend the frontal edge of the sole into the profile of the metal insert.

20. (canceled)

21. (canceled)

22. The horseshoe of claim 1, wherein an upper surface of the sole comprises a resiliently deformable lip extending around, and spaced radially outwardly of, the peripheral edge of the sole.

23. (canceled)

24. A horseshoe comprising a nail head-receiving crease, the crease comprising a relatively narrow groove extending around a floor-engaging surface of the horseshoe, wherein the crease comprises a plurality of radially inwardly and radially outwardly displaced notches for receipt, in use, of nail heads at different radial and circumferential positions.

25. (canceled)

26. The horseshoe of claim 24, wherein the notches are shaped and sized to snugly receive one side of the head of a nail, and wherein, in use, the opposite side of the nail abuts or engages the opposite side wall of the crease.

27. (canceled)

28. (canceled)

29. (canceled)

30. (canceled)

31. (canceled)

32. The horseshoe of claim 24, when adhesively bonded to a hoof, further comprising a locator suitable, in use, for temporarily affixing the horseshoe to the hoof, the locator comprising a planar spacer element having a thickness corresponding to the desired final thickness of the said adhesive and a pair of projections extending outwardly from opposite faces of the spacer element, a first one of the projections having a pointed shape and being adapted, in use, to be seated into the lamellae of a horse's hoof, and the other one of the projections having a generally cuboid shape adapted, in use, to locate in a nail hole on the solar side of a horseshoe.

33. The horseshoe of claim 1, when adhesively bonded to a hoof, further comprising a locator suitable, in use, for temporarily affixing the horseshoe to the hoof, the locator comprising a planar spacer element having a thickness corresponding to the desired final thickness of the said adhesive and a pair of projections extending outwardly from opposite faces of the spacer element, a first one of the projections having a pointed shape and being adapted, in use, to be seated into the lamellae of a horse's hoof, and the other one of the projections having a generally cuboid shape adapted, in use, to locate in a nail hole on the solar side of a horseshoe.

34. The horseshoe of claim 33, wherein each notch comprises an indentation extending into an inner or an outer sidewall of the crease.
